(19) United States
(12) Patent Application Publication
(10) Pub. No.: US 2021/0354231 A1
(43) Pub. Date: Nov. 18, 2021

(54) FRICTION STIR WELDING FOR CERAMIC APPLICATIONS

(71) Applicant: Lam Research Corporation, Fremont, CA (US)

(72) Inventor: Adam Mace, Morga Hill, CA (US)

(21) Appl. No.: 17/281,949

(22) PCT Filed: Sep. 17, 2019
(86) PCT No.: PCT/US2019/051588

§ 371 Date: Mar. 31, 2021

Related U.S. Application Data
(60) Provisional application No. 62/740,838, filed on Oct. 3, 2018.

(51) Int. Cl. B23K 20/233; B23K 20/12

(52) U.S. Cl. CPC B23K 20/2333; B23K 2103/18; B23K 20/126; B23K 20/125

(57) ABSTRACT

Systems and methods for joining a substrate of metallic material to a substrate of ceramic material using friction stir welding are provided. In one example, a method includes arranging an edge of the substrate of metallic material next to an edge of the substrate of ceramic material, and advancing a spinning engagement element of a friction stir welding tool through an edge zone of the substrate of metallic material located adjacent the edge of the substrate of metallic material, thereby to form a friction stir weld between the substrate of metallic material and the substrate of ceramic material. The method may also include advancing the spinning engagement element through the edge zone of the substrate of metallic material without touching, by the engagement element, the edge of the substrate of ceramic material.

### CLAIM OF PRIORITY

This application claims the benefit of priority to U.S. Provisional Patent Application No. 62/740,838, to Mace, entitled FRICTION STIR WELDING FOR CERAMIC APPLICATIONS filed on Oct. 3, 2018, which is incorporated by reference herein in its entirety.

### FIELD

The present disclosure relates generally to friction stir welding. In a more particular aspect, it relates to the use of friction stir welding in joining a metallic material, such as aluminum, to a ceramic material for purposes of creating process chamber components for semi-conductor manufacturing equipment.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In semiconductor manufacturing applications, it is important to provide strongly sealed vacuum for processing chambers. Such processing chambers are also often required to withstand voltage differentials between processing components. In some instances, ceramic materials are used for this purpose in view of their electrical insulating properties.

A problem arises, however, when seeking to create effective vacuum seals between metallic and ceramic materials. For example, a traditional elastomeric O-ring or adhesive seal such as silicone or epoxy, when exposed to process gases and plasma radicals, can be degraded or eroded leading to failure.

In other sealing applications, a barrier for preventing radical attack of venerable materials is conventionally formed by establishing a tightly controlled gap between adjoining surfaces. Alternatively, a sacrificial material can be placed in the gap to block encroaching radicals.

Still further, in other sealing methods, ceramic sleeves can be used to create an electrically insulating via through an aluminum plate. In this instance however, an insulative spray coat layer is often required to be applied over the transitional zone to strengthen insulative properties of the joint. Often times the method used to join the ceramic to the aluminum plate creates a weakness where the spray coat layer will crack. The present disclosure seeks to address these problems.

### SUMMARY

In some embodiments, a friction stir welding system comprises a friction stir welding tool including an engagement element; a support for a substrate of metallic material; a support for a substrate of ceramic material; a clamp means for holding an edge of the substrate of metallic material next to an edge of the substrate of ceramic material; and a drive means for advancing the engagement element of the friction stir welding tool, while spinning, through an edge zone of the substrate of metallic material clamped adjacent the edge of the substrate of metallic material, thereby to form a friction stir weld between the substrate of metallic material and the substrate of ceramic material.

In some embodiments, the drive means is adapted to advance the spinning engagement element of the friction stir welding tool through the edge zone of the substrate of metallic material without touching the edge of the substrate of ceramic material.

In some embodiments, the clamp means is adapted to hold the respective edges of the substrate of metallic material and the substrate of ceramic material in physical contact with one another.

In some embodiments, the clamp means is adapted to leave a gap between the respective edges of the substrate of metallic material and the substrate of ceramic material, the width of the gap sized to allow metallic material softened by the passing of the spinning engagement element to bridge the gap to connect with the edge of the substrate of ceramic material.

In some embodiments, the drive means is adapted to cause the spinning engagement element to rotate at a rotational speed in the range of 200-2500 revolutions per minute (RPM) while the spinning engagement element advances through the edge zone of the substrate of metallic material.

In some embodiments, the drive means is adapted to cause the spinning engagement element to advance through the edge zone of the substrate of metallic material at a linear speed in the range of 10-300 millimetres per minute (mm/min).

In some embodiments, the drive means is adapted to cause the spinning engagement element to exert a compressive force in the range 2-40 Kilo-Newtons (KN) on the substrate of metallic material while the spinning engagement element advances through the edge zone of the substrate of metallic material.

In some embodiments, at least one of the respective edges of the substrate of metallic material and the substrate of ceramic material includes an edge profile, wherein an angle of the edge profile matches or complements an angle of taper of the spinning engagement element in use.

In some embodiments, the metallic material is aluminum.

### DESCRIPTION OF THE DRAWINGS

Some embodiments are illustrated by way of example and not limitation in the views of the accompanying drawings:

FIG. 1 is a pictorial view of an arrangement of substrates of aluminum and ceramic material, according to an example embodiment.

FIGS. 2-3 are sectional views of an arrangement of substrates of aluminum and ceramic material, according to example embodiments.

FIG. 4 is a sectional view of a friction stir weld, according to an example embodiment.

FIGS. 5A-7B are sectional views of an arrangement of substrates of aluminum and ceramic material, according to example embodiments.

FIG. 8 is a flowchart of a method, according to an example embodiment.

FIG. 9 is a block diagram illustrating an example of a machine by which one or more example embodiments may be controlled.

### DESCRIPTION

The description that follows includes systems, methods, techniques, instruction sequences, and computing machine program products that embody illustrative embodiments of the present invention. In the following description, for purposes of explanation, numerous specific details are set forth in order to provide a thorough understanding of example embodiments. It will be evident, however, to one skilled in the art, that the present embodiments may be practiced without these specific details.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any data as described below, and in the drawings, that form a part of this document: copyright Lam Research Corporation, 2018, all rights reserved.

In some examples, friction stir welding (FSW) is used to join a metallic material to a ceramic material and form a seal therebetween. In one example, FSW is used to join a layer or substrate of aluminum to a layer or substrate of ceramic material. During the joining process, a fast-spinning FSW tool “softens” (by frictional heat) the aluminum through which it passes and exerts a compressive load on the adjacent ceramic substrate and is believed to create a seal between the aluminum and ceramic by pushing some of the softened aluminum material into the pores or interstices of the ceramic material. A seal thus formed can be used as a vacuum seal, or a barrier seal to prevent radical attack, or as a transitional technology that can be used to prevent or at least minimize the cracking that would otherwise occur in a ceramic spray coat applied over an aluminum-to-ceramic transition as discussed above.

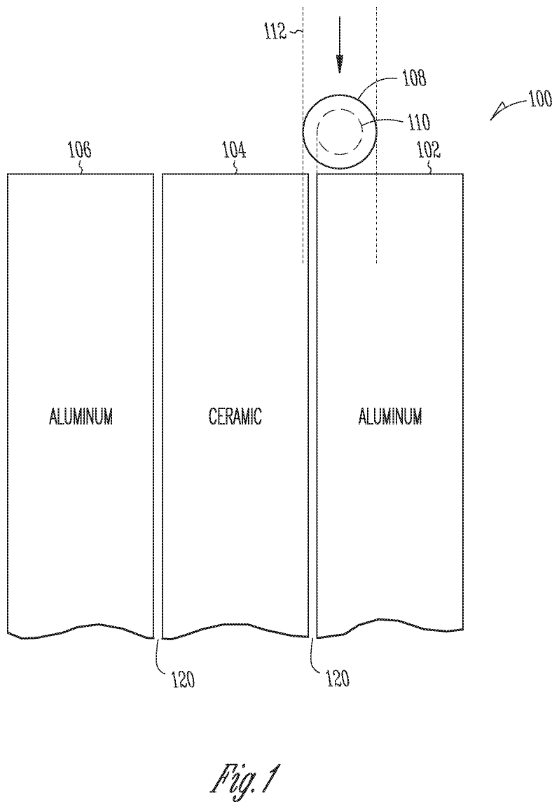

Turning now to FIG. 1, an arrangement 100 of substrates of aluminum and ceramic material is shown. A first aluminum substrate 102 lies adjacent a central ceramic substrate 104. On the other side of the ceramic substrate 104 a second aluminum substrate 106 is arranged. The following discussion will focus on the use of FSW to create a seal between the aluminum substrate 102 and the central ceramic substrate 104. The process may also be used to create a second seal between the second aluminum substrate 106 and the central ceramic substrate 104.

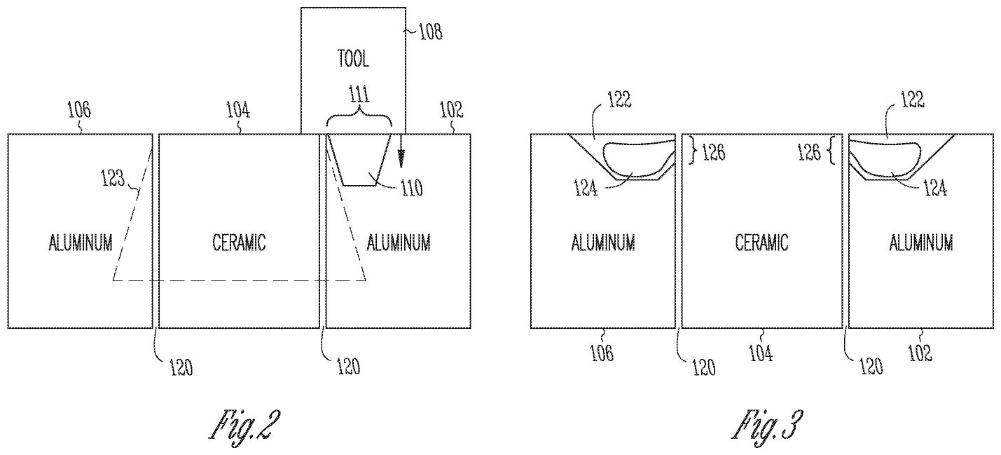

The aluminum substrate 102 and the ceramic substrate 104 are arranged, as shown, in a close or abutting relationship prior to being joined. A gap 120 between the substrates 102 and 104 lies generally in the path 112 of an FSW tool 108. The FSW tool 108 has a substrate stirring or engagement element 110 which can more clearly be seen in FIG. 2. The engagement element 110 of the FSW tool 108 can engage frictionally with a metal material (in this case aluminium), while spinning at very high speed to generate enormous heat and soften the aluminum as the tool 108 proceeds down the path 112. The spinning engagement element 110 in effect “passes through” the softened aluminum material in use and it is believed to urge some of the softened aluminum material, under compression of the force inducing the linear movement of the engagement element 110 through the aluminum material, into the pores or interstices (or at least some of the pores or interstices) located at the edge of the substrate of ceramic material 104 to form a strong bond between the two substrates 102 and 104, and thereby create an integral seal therebetween. In some examples, the engagement element 110 of the FSW tool 108 spins in a direction such that a front face of the engagement element 110 moves towards the edge of the ceramic substrate 104 during rotation. This direction of rotation may serve to promote passage of the softened aluminum material into the ceramic substrate 104 to form a strong seal.

The substrate of aluminum 102 and the substrate of ceramic material 104 may, in some examples, need to be held fast with respect to one another, at least initially, so that they do not part upon passage of the FSW tool 108 along the pathway 112. In some examples, the aluminium substrate 102 and the ceramic substrate 104 are arranged to physically touch each other i.e. in abutment with one another, prior to being joined and, in some examples, as they are being joined together. In other examples, a narrow gap 120 is left between the two substrates 102 and 104. In some examples, the width of the gap 120 may range from a fraction of a millimetre to 10 mm. Smaller or larger gap widths are possible, depending on certain factors. For example, the width of the gap 120, or whether even to use a gap 120 at all, may be dependent on the size, rotational speed, and compressive force that can be exerted by the FSW tool 108 in use, as well as the intrinsic properties of the materials being joined together. In some examples, the width of the gap 120 may be somewhat or fully independent of these factors as long as the gap 120 is provided adjacent or within the anticipated path 112 of the FSW tool 108, or its engagement element 110. Thus, unless otherwise clear from the context, the numeral 120 shown in the accompanying drawings is intended to designate both a gap 120 or a line of abutment between two separate substrates 102 and 104.

A sectional side view of the aluminum substrates 102 and 106, with the ceramic substrate 104 positioned between them, is provided in FIG. 2 of the accompanying drawings. As shown, in some examples, the FSW tool 108, or more precisely the engagement element 110 thereof, passes through an edge portion or zone 111 of the aluminum substrate 102 located just next to or alongside the gap 120 or the abutting edge of the ceramic substrate 104 to which the aluminum substrate 102 is to be joined. In some examples, the engagement element 110 of the FSW tool 108 passes along the gap or abutment line 120 without directly touching the substrate of ceramic material 104. In some applications, the ceramic material 104 may be very brittle and might shatter or crack were it to be impacted by the FSW tool 108, particularly if this were to occur with a relatively high degree of force or spin.

In some examples, an edge profile of one or more of the aluminum substrates 102 and 106, or the ceramic substrate 104, is designed to promote engagement with the engagement element 110 of the FSW tool 108 during the friction welding process. For example, an example alternate edge profile of the ceramic substrate 104 is shown in dotted sectional outline at 123. Other edge profiles are possible. As opposed to presenting a perpendicular face (in the view) running along one side of the gap 120, an inclined or triangular profile 123 as shown may serve to improve direct engagement with the engagement element 110 of the FSW tool 108. The enhanced engagement may promote the urging and passage of softened aluminum material into the pores of the angled side of the ceramic material of the substrate 104. In some examples, the angle of inclination of the triangular edge profile 123 may substantially match or complement the angle of taper of the engagement element 110 of the FSW tool 108. Various alternate engagement tool angles and complementary edge profiles for the substrates of ceramic and aluminum material 102 and 104 are possible.

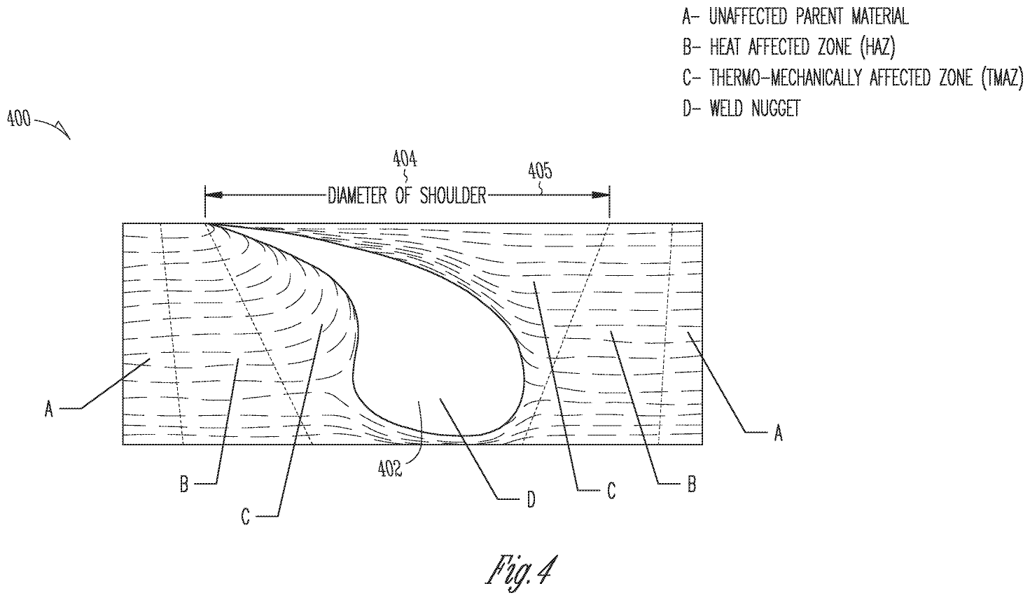

Turning now to FIG. 3, the same substrates 102-106 are again illustrated in sectional view, but in this view regions of heated affected aluminum material are shown adjacent each gap 120. The regions include a heat affected zone (HAZ) 122 and a thermo-mechanically affected zone (TMAZ) 124. In some examples, these regions are softened for a short period of time during the friction welding process. Edge portions 126 of these HAZ and TMAZ zones 122 and 124 located adjacent their respective gaps (or joint lines) 120 are forced, during FSW, into the adjacent pores or interstices of the ceramic material of the substrate 104.

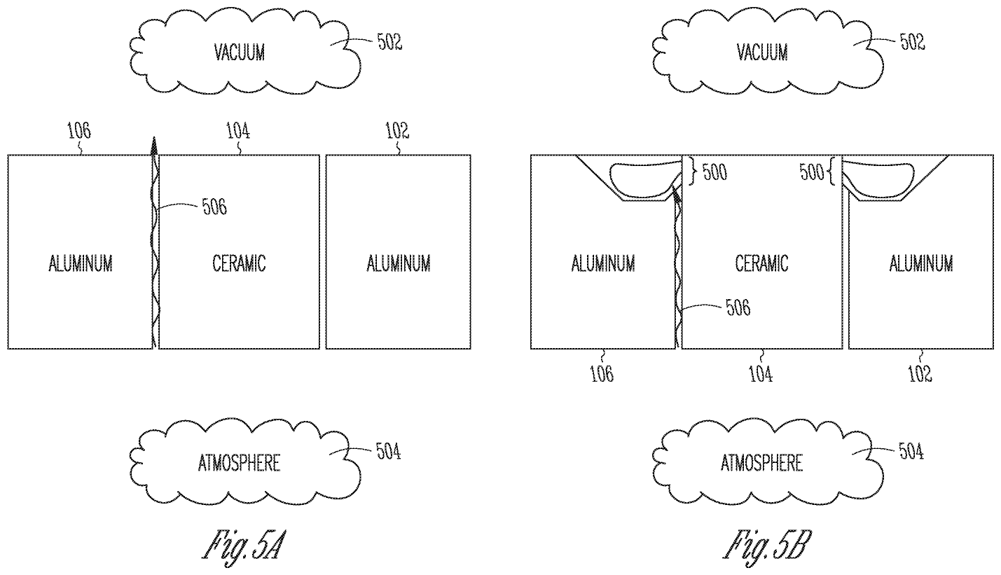

Further aspects of a friction stir weld are shown in FIG. 4 of the accompanying drawings. Here, a cross-sectional view 400 of a region adjacent a seam of welded material is visible in the view. Here, unaffected parent material on either side of or surrounding a weld nugget 402 is shown in zones A. The weld nugget 402 is also marked as zone D in the view. The weld nugget 402 has a shoulder shown at 404. The diameter of the shoulder of the weld nugget 402 is denoted by the arrow 405. A heat affected zone (HAZ) 122 located on either side of or surrounding the weld nugget 402, inward of the unaffected material in zone A, is shown in zone B. A thermo-mechanically affected zone (TMHZ) 124 located on either side of or surrounding the weld nugget 402, and inward of the heat affected zone (HAZ) 122, is shown in zone C. Without wishing to be bound by theory, it is believed to be zones B and C (i.e. the HAZ and TMHZ zones) that contribute most directly to the creation of a seal between substrates of a metallic and a ceramic material 102 or 106, 104 in accordance with the present disclosure.

In some examples, the FSW tool 108 spins in use at revolutions in the range 200-2500 RPM, has a path speed in the range 10-300 millimetres per minute, and exerts a compressive force of 2-40 kN on the substrate of metallic material while the spinning engagement element advances through the edge zone of the substrate of metallic material.

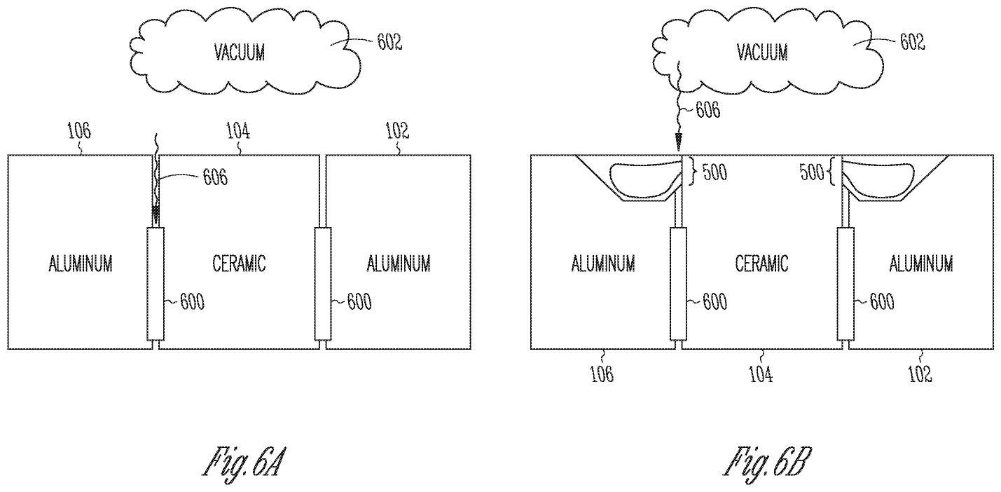

Turning now to FIGS. 5A-5B, sectional views of the aluminum substrates 102 and 106, and the ceramic substrate 104 located between them, are given. In each view, a vacuum 502 exists above the illustrated substrates, and an atmospheric pressure 504 exists below the substrates. FIG. 5A depicts leakage of air or gas from the atmospheric pressure 504 side of the illustrated substrates 102-106 to the vacuum 502 side of the substrates 102, 104, 106. The leakage of air or gas is shown by the curly arrow 506. The friction stir welds formed in the zones 500 shown in FIG. 5B are formed in the manner described above and prevent exit of air or gas from the atmospheric pressure 504 side of the substrates 102-106 to the vacuum 502 side of the substrates 102-106. The areas of the aluminum substrates 102 and 106 which were softened by the FSW process described above have been pushed into the pores or interstices of the ceramic material of the substrate 104 in the zones 500 to form a strong seal, or bond.

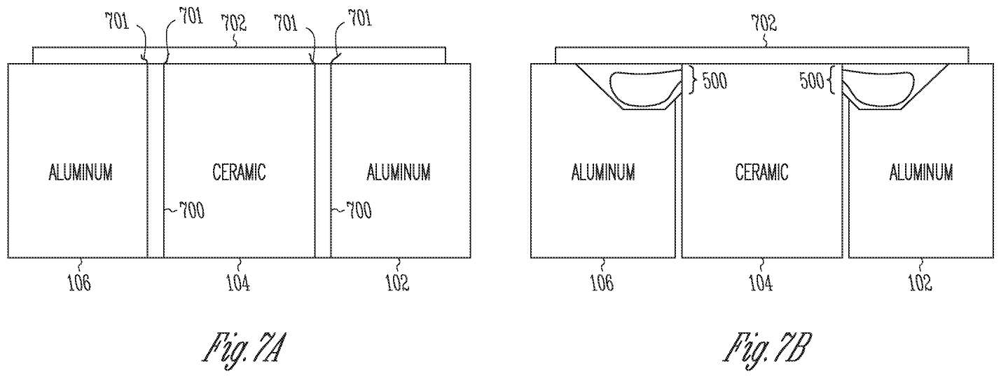

Turning now to FIGS. 6A-6B, the view on the left in FIG. 6A illustrates a method of forming a radical barrier between joined materials to prevent radical attack therebetween. A plasma gas containing radicals has, in this instance, been formed in a vacuum on the vacuum 602 side of the illustrated substrates 102-106 during a wafer processing phase, for example. An atmospheric seal 600 has been interposed between the ceramic and aluminum materials, as shown, and the curly arrow 606 depicts radicals attacking the seal 600 from the upper, vacuum 602 side of the substrates 102-106. This problem is addressed by the friction stir welds created in the zones 500 shown in FIG. 5B. The friction stir welds in the zones 500 are formed in the manner described above and prevent radicals from attacking the seal 600. The radicals are unable to pass through the friction stir welds in the zones 500. The areas of the aluminum substrates 102 and 106 which were softened by the FSW process described above have been pushed into the pores or interstices of the ceramic material of the substrate 104 in the zones 500 to form a barrier seal used to protect the atmospheric seal or bond 600.

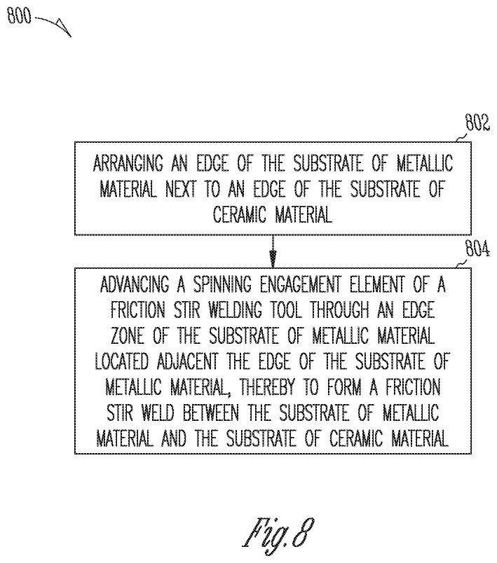

Turning now to FIGS. 7A-7B, the view on the left in FIG. 7A illustrates a method of forming an electrically insulative via through an aluminum substrate. In this case the aluminum substrates 102 and 106, and the ceramic substrate 104 have been joined with a bonding material, such as a silicone adhesive, to form a seal 700 between the substrates. It is typical, in this situation, to apply a spray coat or layer 702 over transitional zones of the substrates 102-106 located closely adjacent the seal 700, as shown. One potential issue with this arrangement 100 is the formation of cracks at the bond line between the spray coat 702 and the seal 700.

This problem is addressed by the friction stir welds created in the zones 500 shown in FIG. 7B. The areas of the aluminum substrates 102 and 106 which were softened by the FSW process described above have been pushed into the pores or interstices of the ceramic material of the substrate 104 in the zones 500 to form a compressive force. The compressive force generated in the zone 500 creates a stable joint that will not flexor separate that might lead to the formation of cracks in the overlying spray coat 702.

Thus, in some examples, there is provided a FSW system as summarized above.

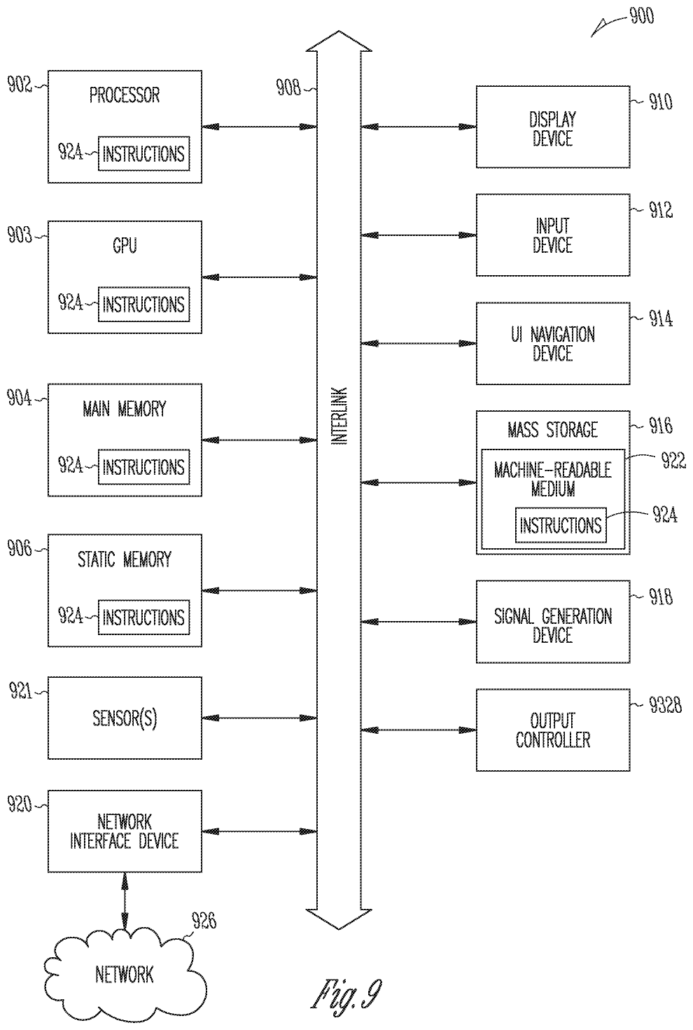

The present disclosure also includes example methods. In one example, with reference to FIG. 8, a method 800 for joining a substrate of metallic material to a substrate of ceramic material comprises: at 802, arranging an edge of the substrate of metallic material next to an edge of the substrate of ceramic material; at 804, advancing a spinning engagement element of a friction stir welding tool through an edge zone of the substrate of metallic material located adjacent the edge of the substrate of metallic material, thereby to form a friction stir weld between the substrate of metallic material and the substrate of ceramic material.

In some examples, the operation 804 of advancing the spinning engagement element of the friction stir welding tool through the edge zone of the substrate of metallic material further comprises advancing the spinning engagement element through the edge zone of the substrate of metallic material without touching, by the engagement element, the edge of the substrate of ceramic material.

In some examples, the operation 802 of arranging the edge of the substrate of metallic material next to the edge of the substrate of ceramic material includes placing the respective edges in physical contact with one another.

In some examples, arranging the edge of the substrate of metallic material next to the edge of the substrate of ceramic material includes leaving a gap between the respective edges of the substrate of metallic material and the substrate of ceramic material, the width of the gap sized to allow metallic material softened by the passing of the spinning engagement element to bridge the gap to connect with the edge of the substrate of ceramic material.

In some examples, the method 800 further comprises causing the spinning engagement element to rotate at a rotational speed in the range of 200-2500 revolutions per minute (RPM) while the spinning engagement element advances through the edge zone of the substrate of metallic material.

In some examples, the method 800 further comprises causing the spinning engagement element to advance through the edge zone of the substrate of metallic material at a linear speed in the range of 10-300 millimeters per minute (mm/min).

In some examples, the method 800 further comprises causing the spinning engagement element to exert a compressive force in the range 2-40 Kilo-Newtons (KN) on the substrate of metallic material while the spinning engagement element advances through the edge zone of the substrate of metallic material.

In some examples, the method 800 further comprises providing an edge profile for at least one of the respective edges of the substrate of metallic material and the substrate of ceramic material, wherein an angle of the edge profile matches or complements an angle of taper of the spinning engagement element in use. In some examples, the metallic material is aluminum.

In some examples, a non-transitory machine-readable medium includes instructions 924 that, when read by a machine 900, cause the machine 900 to control operations in methods comprising at least the non-limiting example operations summarized above.

FIG. 9 is a block diagram illustrating an example of a machine 900 upon which one or more example process embodiments described herein may be implemented, or by which one or more example process embodiments described herein may be controlled. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in a peer-to-peer (P2P) (or other distributed) network environment. Further, while only a single machine 900 is illustrated, the term “machine” shall also be taken to include any collection of machines that individually or jointly execute a set (or multiple sets) of instructions 924 to perform any one or more of the methodologies discussed herein, such as via cloud computing, software as a service (SaaS), or other computer cluster configurations.

Examples, as described herein, may include, or may operate by, logic and/or a number of components or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions 924 of the specific operation. In connecting the physical components, the underlying electrical properties of a hardware constituent are changed (for example, from an insulator to a conductor or vice versa). The instructions 924 enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 900 may include a hardware processor 902 (e.g., a central processing unit (CPU), a hardware processor core, or any combination thereof), a graphics processing unit (GPU) 903, a main memory 904, and a static memory 906, some or all of which may communicate with each other via an interlink (e.g., bus) 908. The machine 900 may further include a display device 910, an alphanumeric input device 912 (e.g., a keyboard), and a user interface (UI) navigation device 914 (e.g., a mouse). In an example, the display device 910, alphanumeric input device 912, and UI navigation device 914 may be a touch screen display. The machine 900 may additionally include a mass storage device (e.g., drive unit) 916, a signal generation device 918 (e.g., a speaker), a network interface device 920, and one or more sensors 921, such as a Global Positioning System (GPS) sensor, compass, accelerometer, or another sensor. The machine 900 may include an output controller 928, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, within the hardware processor 902, or within the GPU 903 during execution thereof by the machine 900. In an example, one or any combination of the hardware processor 902, the GPU 903, the main memory 904, the static memory 906, or the mass storage device 916 may constitute machine-readable media 922.

While the machine-readable medium 922 is illustrated as a single medium, the term “machine-readable medium” may include a single medium, or multiple media (e.g., a centralized or distributed database, and/or associated caches and servers) configured to store the one or more instructions 924.

The term “machine-readable medium” may include any medium that can store, encode, or carry instructions 924 for execution by the machine 900 and that cause the machine 900 to perform any one or more of the techniques of the present disclosure, or that can store, encode, or carry data structures used by or associated with such instructions 924. Non-limiting machine-readable medium examples may include solid-state memories, and optical and magnetic media. In an example, a massed machine-readable medium comprises a machine-readable medium 922 with a plurality of particles having invariant (e.g., rest) mass. Accordingly, massed machine-readable media are not transitory propagating signals. Specific examples of massed machine-readable media may include non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks. The instructions 924 may further be transmitted or received over a communications network 926 using a transmission medium via the network interface device 920.

### EXAMPLES

1. A method for joining a substrate of metallic material to a substrate of ceramic material, the method comprising: arranging an edge of the substrate of metallic material next to an edge of the substrate of ceramic material; advancing a spinning engagement element of a friction stir welding tool through an edge zone of the substrate of metallic material located adjacent the edge of the substrate of metallic material, thereby to form a friction stir weld between the substrate of metallic material and the substrate of ceramic material.

2. The method of example 1, wherein advancing the spinning engagement element of the friction stir welding tool through the edge zone of the substrate of metallic material further comprises advancing the spinning engagement element through the edge zone of the substrate of metallic material without touching, by the engagement element, the edge of the substrate of ceramic material.

3. The method of example 1 or 2, wherein arranging the edge of the substrate of metallic material next to the edge of the substrate of ceramic material includes placing the respective edges in physical contact with one another.

4. The method of any one or more of examples 1 to 3, wherein arranging the edge of the substrate of metallic material next to the edge of the substrate of ceramic material includes leaving a gap between the respective edges of the substrate of metallic material and the substrate of ceramic material, the width of the gap sized to allow metallic material softened by the passing of the spinning engagement element to bridge the gap to connect with the edge of the substrate of ceramic material.

5. The method of any one or more of examples 1-4, further comprising causing the spinning engagement element to rotate at a rotational speed in the range of 200-2500 revolutions per minute (RPM) while the spinning engagement element advances through the edge zone of the substrate of metallic material.

6. The method of any one or more of examples 1-5, further comprising causing the spinning engagement element to advance through the edge zone of the substrate of metallic material at a linear speed in the range of 10-300 millimetres per minute (mm/min).

7. The method of any one or more of examples 1-6, further comprising causing the spinning engagement element to exert a compressive force in the range 2-40 Kilo-Newtons (KN) on the substrate of metallic material while the spinning engagement element advances through the edge zone of the substrate of metallic material.

8. The method of any one or more of examples 1-7, further comprising providing an edge profile for at least one of the respective edges of the substrate of metallic material and the substrate of ceramic material, wherein an angle of the edge profile matches or complements an angle of taper of the spinning engagement element in use.

9. The method of any one or more of examples 1-8, wherein the metallic material is aluminum.

10. A friction stir welding system comprising: a friction stir welding tool including an engagement element; a support for a substrate of metallic material; a support for a substrate of ceramic material; a clamp means for holding an edge of the substrate of metallic material next to an edge of the substrate of ceramic material; and a drive means for advancing the engagement element of the friction stir welding tool, while spinning, through an edge zone of the substrate of metallic material clamped adjacent the edge of the substrate of metallic material, thereby to form a friction stir weld between the substrate of metallic material and the substrate of ceramic material.

11. The system of example 10, wherein the drive means is adapted to advance the spinning engagement element of the friction stir welding tool through the edge zone of the substrate of metallic material without touching the edge of the substrate of ceramic material.

12. The system of either one of examples 10 and 11, wherein the clamp means is adapted to hold the respective edges of the substrate of metallic material and the substrate of ceramic material in physical contact with one another.

13. The system of any one or more of examples 10-12, wherein the clamp means is adapted to leave a gap between the respective edges of the substrate of metallic material and the substrate of ceramic material, the width of the gap sized to allow metallic material softened by the passing of the spinning engagement element to bridge the gap to connect with the edge of the substrate of ceramic material.

14. The system of any one or more of examples 10-13, wherein the drive means is adapted to cause the spinning engagement element to rotate at a rotational speed in the range of 200-2500 revolutions per minute (RPM) while the spinning engagement element advances through the edge zone of the substrate of metallic material.

15. The system of any one or more of examples 10-14, wherein the drive means is adapted to cause the spinning engagement element to advance through the edge zone of the substrate of metallic material at a linear speed in the range of 10-300 millimetres per minute (mm/min).

16. The system of any one or more of examples 10-15, wherein the drive means is adapted to cause the spinning engagement element to exert a compressive force in the range 2-40 Kilo-Newtons (KN) on the substrate of metallic material while the spinning engagement element advances through the edge zone of the substrate of metallic material.

17. The system of any one or more of examples 10-16, wherein at least one of the respective edges of the substrate of metallic material and the substrate of ceramic material includes an edge profile, wherein an angle of the edge profile matches or complements an angle of taper of the spinning engagement element in use.

18. The system of any one or more of examples claim 10-17, wherein the metallic material is aluminum.

19. A machine-readable medium including instructions which, when read by a machine, cause the machine to control operations in a method for joining a substrate of metallic material to a substrate of ceramic material, the operations comprising, at least: arranging an edge of the substrate of metallic material next to an edge of the substrate of ceramic material; and advancing a spinning engagement element of a friction stir welding tool through an edge zone of the substrate of metallic material located adjacent the edge of the substrate of metallic material, thereby to form a friction stir weld between the substrate of metallic material and the substrate of ceramic material.

20. The medium of example 19, wherein the operations further comprise advancing the spinning engagement element of the friction stir welding tool through the edge zone of the substrate of metallic material without touching, by the engagement element, the edge of the substrate of ceramic material.

### Non-Limiting Disclosure

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art upon reviewing the above description.

What is claimed is:

1. A method for joining a substrate of metallic material to a substrate of ceramic material, the method comprising:
arranging an edge of the substrate of metallic material next to an edge of the substrate of ceramic material;
advancing a spinning engagement element of a friction stir welding tool through an edge zone of the substrate of metallic material located adjacent the edge of the substrate of metallic material, thereby to form a friction stir weld between the substrate of metallic material and the substrate of ceramic material.

2. The method of claim 1, wherein advancing the spinning engagement element of the friction stir welding tool through the edge zone of the substrate of metallic material further comprises advancing the spinning engagement element through the edge zone of the substrate of metallic material without touching, by the engagement element, the edge of the substrate of ceramic material.

3. The method of claim 1, wherein arranging the edge of the substrate of metallic material next to the edge of the substrate of ceramic material includes placing the respective edges in physical contact with one another.

4. The method of claim 1, wherein arranging the edge of the substrate of metallic material next to the edge of the substrate of ceramic material includes leaving a gap between the respective edges of the substrate of metallic material and the substrate of ceramic material, the width of the gap sized to allow metallic material softened by the passing of the spinning engagement element to bridge the gap to connect with the edge of the substrate of ceramic material.

5. The method of claim 1, further comprising causing the spinning engagement element to rotate at a rotational speed in the range of 200-2500 revolutions per minute (RPM) while the spinning engagement element advances through the edge zone of the substrate of metallic material.

6. The method of claim 1, further comprising causing the spinning engagement element to advance through the edge zone of the substrate of metallic material at a linear speed in the range of 10-300 millimetres per minute (mm/min).

7. The method of claim 1, further comprising causing the spinning engagement element to exert a compressive force in the range 2-40 Kilo-Newtons (KN) on the substrate of metallic material while the spinning engagement element advances through the edge zone of the substrate of metallic material.

8. The method of claim 1, further comprising providing an edge profile for at least one of the respective edges of the substrate of metallic material and the substrate of ceramic material, wherein an angle of the edge profile matches or complements an angle of taper of the spinning engagement element in use.

9. The method of claim 1, wherein the metallic material is aluminum.

10. A friction stir welding system comprising:
a friction stir welding tool including an engagement element;
a support for a substrate of metallic material;
a support for a substrate of ceramic material;
a clamp means for holding an edge of the substrate of metallic material next to an edge of the substrate of ceramic material; and
a drive means for advancing the engagement element of the friction stir welding tool, while spinning, through an edge zone of the substrate of metallic material clamped adjacent the edge of the substrate of metallic material, thereby to form a friction stir weld between the substrate of metallic material and the substrate of ceramic material.

11. The system of claim 10, wherein the drive means is adapted to advance the spinning engagement element of the friction stir welding tool through the edge zone of the substrate of metallic material without touching the edge of the substrate of ceramic material.

12. The system of claim 10, wherein the clamp means is adapted to hold the respective edges of the substrate of metallic material and the substrate of ceramic material in physical contact with one another.

13. The system of claim 10, wherein the clamp means is adapted to leave a gap between the respective edges of the substrate of metallic material and the substrate of ceramic material, the width of the gap sized to allow metallic material softened by the passing of the spinning engagement element to bridge the gap to connect with the edge of the substrate of ceramic material.

14. The system of claim 10, wherein the drive means is adapted to cause the spinning engagement element to rotate at a rotational speed in the range of 200-2500 revolutions per minute (RPM) while the spinning engagement element advances through the edge zone of the substrate of metallic material.

15. The system of claim 10, wherein the drive means is adapted to cause the spinning engagement element to advance through the edge zone of the substrate of metallic material at a linear speed in the range of 10-300 millimetres per minute (mm/min).

16. The system of claim 10, wherein the drive means is adapted to cause the spinning engagement element to exert a compressive force in the range 2-40 Kilo-Newtons (KN) on the substrate of metallic material while the spinning engagement element advances through the edge zone of the substrate of metallic material.

17. The system of claim 10, wherein at least one of the respective edges of the substrate of metallic material and the substrate of ceramic material includes an edge profile, wherein an angle of the edge profile matches or complements an angle of taper of the spinning engagement element in use.

18. The system of claim 10, wherein the metallic material is aluminum.

19. A machine-readable medium including instructions which, when read by a machine, cause the machine to control operations in a method for joining a substrate of metallic material to a substrate of ceramic material, the operations comprising, at least:
arranging an edge of the substrate of metallic material next to an edge of the substrate of ceramic material; and
advancing a spinning engagement element of a friction stir welding tool through an edge zone of the substrate of metallic material located adjacent the edge of the substrate of metallic material, thereby to form a friction stir weld between the substrate of metallic material and the substrate of ceramic material.

20. The medium of claim 19, wherein the operations further comprise advancing the spinning engagement element of the friction stir welding tool through the edge zone of the substrate of metallic material without touching, by the engagement element, the edge of the substrate of ceramic material.
